(19) United States
(12) Patent Application Publication
(10) Pub. No.: US 2026/0110150 A1
(43) Pub. Date: Apr. 23, 2026

(54) TAIJI FISHWAY STRUCTURE

(71) Applicant: Changsha Hetong Ecological Environment Technology Co., Ltd, Changsha (CN)

(72) Inventors: Xiaoping LIU, Changsha (CN); Yukang YE, Changsha (CN); Zhe PENG, Changsha (CN); Yuyuan TANG, Changsha (CN); Wei LIU, Changsha (CN); Tianyu SU, Changsha (CN); Zixuan CHEN, Changsha (CN); Jia XU, Changsha (CN); Hao CHEN, Changsha (CN); Jiaqiang ZHANG, Changsha (CN); Xiaolong XIE, Changsha (CN); Yating LIU, Changsha (CN); Yuqing LIU, Changsha (CN); Siyu CHEN, Changsha (CN)

(73) Assignee: Changsha Hetong Ecological Environment Technology Co., Ltd, Changsha (CN)

(21) Appl. No.: 19/291,185

(22) Filed: Aug. 5, 2025

(30) Foreign Application Priority Data
Oct. 18, 2024 (CN) 2024114622649

(51) Int. Cl. E02B 8/08; A01K 63/00

(52) U.S. Cl. CPC E02B 8/085; A01K 63/00

(57) ABSTRACT

A Taiji fishway structure includes fishway pool chamber units arranged sequentially along a water flow direction, each fishway pool chamber unit includes an curved side wall, an curved deflector, and a first longitudinal side wall, a fishway vertical partition plate, and a second longitudinal side wall provided on the same side of the fishway. A head end of the curved deflector of the i-th fishway pool chamber unit connects to a head end of the curved side wall in the (i+1)th fishway pool chamber unit, and forms a fish passage vertical slot that matches target fish body size with an end of the fishway vertical partition plate in the (i+1)th fishway pool chamber unit, and water flow of the i-th fishway pool chamber unit is ejected toward the curved side wall in the (i+1)th fishway pool chamber unit through the fish passage vertical slot.

### CROSS-REFERENCE TO RELATED APPLICATIONS

The application claims priority to Chinese patent application No. 2024114622649, filed on Oct. 18, 2024, the entire contents of which are incorporated herein by reference.

### TECHNICAL FIELD

The present disclosure relates to a technical field of fishways, in particular to a Taiji fishway structure.

### BACKGROUND

A fishway is an artificial channel for fish to migrate safely, timely and effectively. It mainly includes fishway inlet and outlet, trough, guidance and auxiliary facilities. There are two main types of fishways: natural-like fishways (natural fishway ladders, fishway slopes and fishway bypasses) and technical fishways (vertical slot fishways, pool-weir fishways, submerged fishways, culvert fishways and Daniel fishways). Among them, the vertical slot fishway is one of the most widely used and effective fishway types because of its simple structure and ability to adapt to changing upstream and downstream water levels. The vertical slot fishway was first developed in North America mainly to solve the problem of salmon upstream migration in steep river sections, so it is also called the “salmon fishway”.

The vertical slot fishway shown in FIG. 1 is considered to be a standard vertical slot fishway. The water flow characteristics and energy dissipation principle of the standard vertical slot fishway are as follows: it consists of an inclined (or stepped) rectangular channel, which is divided into a plurality of pools. The water flows from an upper pool chamber to a lower pool chamber through a vertically oriented slot, forming a jet at each vertical slot, and energy dissipation occurs through jet mixing in each pool chamber. The shear stress between the jet and the recirculating water body is dominant, while in contrast, the shear stress between the jet and the bed or wall is relatively weak. Therefore, the key to designing a standard vertical slot fishway is to use the impact shear energy dissipation of the high-speed jet at the vertical slot, and to control the vertical slot flow velocity to be no greater than the burst flow velocity of the target fish, and to find a suitable balance between these two contradictions.

In order to improve the energy dissipation effect of vertical slot fishway, domestic and foreign scientific and technological researchers have conducted a lot of research work, such as arranging some physical barriers (such as circular pipe grids) in the pool chamber of the standard vertical slot fishway to adjust the water flow characteristics of the pool chamber. Although these measures have a certain effect on improving the water flow conditions, they have not been applied in actual projects at present because physical barriers hinder the upstream behavior of fish.

In addition, it is expected to improve the energy dissipation effect by increasing the roughness of side walls and a bottom of the pool chamber in the standard vertical slot fishway. However, the main flow in the standard vertical slot fishway is in a middle of the pool chamber, and the side walls and the bottom generally have low flow velocities or are backflow slow-flow zones, so the effects of the above measures are not obvious.

In view of this, it is necessary to provide a Taiji fishway structure to address or at least mitigate the above-mentioned drawbacks.

### SUMMARY

The main objective of the present disclosure is to provide a Taiji fishway structure to solve problems of poor energy dissipation effect and poor fish passage effect of existing vertical slot fishways.

To achieve the above objective, the present disclosure provides a Taiji fishway structure, including a plurality of fishway pool chamber units arranged in sequence along a water flow direction, each fishway pool chamber unit includes an curved side wall, an curved deflector, and a first longitudinal side wall, a fishway vertical partition plate, and a second longitudinal side wall provided on the same side of the fishway, wherein:
The curved side wall is arranged on an opposite side of the second longitudinal side wall, the curved side wall is bent toward the second longitudinal side wall and extends along the water flow direction, the curved deflector is arranged on an inner side of the curved side wall, and the curved deflector is bent toward the curved side wall, the curved deflector includes a head end and a tail end arranged opposite to each other along the water flow direction, the head end of the curved deflector is connected to a tail end of the curved side wall, and the tail end of the curved deflector extends from the head end of the curved deflector to a middle area of the fishway pool chamber;
The first longitudinal side wall is arranged upstream of the fishway vertical partition plate and extends longitudinally along a fishway, the fishway vertical partition plate is perpendicular to the first longitudinal side wall, and the second longitudinal side wall is arranged downstream of the fishway vertical partition plate and extends longitudinally along the fishway;
The head end of the curved deflector of the i-th fishway pool chamber unit is connected to the head end of the curved side wall in the (i+1)th fishway pool chamber unit, the head end of the curved deflector of the i-th fishway pool chamber unit and the end of the fishway vertical partition plate in the (i+1)th fishway pool chamber unit form a fish passage vertical slot that matches target fish body size, and water flow of the i-th fishway pool chamber unit is ejected toward the curved side wall in the (i+1)th fishway pool chamber unit through the fish passage vertical slot; wherein i is a positive integer, i≥1.

Optionally, the curved side wall of each fishway pool chamber unit includes a first arc segment, a straight segment and a second arc segment connected sequentially along the water flow direction, a tail end of the first arc segment is tangent to a head end of the straight segment, a tail end of the straight segment is tangent to a head end of the second arc segment, and a tail end of the second arc segment is connected to the head end of the curved deflector.

Optionally, the curved deflector is an curved plate with a radius equal to that of the second arc segment, a projected length of the curved deflector on the second longitudinal side wall is ≤L/3, and a distance between the curved deflector and the second longitudinal side wall is ≥B/3, so that a water flow velocity at a confluence of a pool chamber outlet in the fishway pool chamber unit is not greater than a water flow velocity at the fish passage vertical slot; wherein L is a length of the fishway pool chamber unit along the water flow direction, and B is a width of the fishway pool chamber unit.

Optionally, the curved side wall is provided with a plurality of first rib plates arranged at intervals along an extension direction of the curved side wall.

Optionally, the Taiji fishway structure further includes a plurality of fish-attracting and guiding cylinders arranged downstream of the fish passage vertical slot, wherein the plurality of fish-attracting and guiding cylinders are arranged in series.

Optionally, a number of the fish-attracting and guiding cylinders is three, an angle between an arrangement direction of the three fish-attracting and guiding cylinders and the longitudinal direction of the fishway is set to 20°˜30°, and a spacing between a most upstream fish-attracting and guiding cylinder and the end of the fishway vertical partition plate is equal to a width of the fish passage vertical slot, and a spacing between two adjacent fish-attracting and guiding cylinders is set to 2 to 3 times a diameter of the fish-attracting and guiding cylinder.

Optionally, the Taiji fishway structure further includes a plurality of second rib plates and a plurality of third rib plates, wherein the plurality of second rib plates are arranged in an area where the curved deflector is projected on the second longitudinal side wall, and are arranged at intervals along an extension direction of the second longitudinal side wall, and the plurality of third rib plates are arranged on a wall surface of the fishway vertical partition plate close to the second rib plates, and are arranged at intervals along an extension direction of the fishway vertical partition plate.

Optionally, the width of the fish passage vertical slot is set between 0.4 and 0.6 meters, and the width of the fishway pool chamber unit is set between 2.5 and 3.5 meters.

Optionally, the length L of the fishway pool chamber unit along the water flow direction is determined by a formula L=K*B, wherein B is the width of the fishway pool chamber unit, K is a coefficient, and K is taken as 1.25˜1.5.

Optionally, the length l of the fishway vertical partition plate is determined by a formula 1≥B/2.

Compared with the prior art, the present disclosure has the following beneficial effects:

The present disclosure has the advantages of good energy dissipation effect, strong water flow stability, and good fish passage effect. Specifically:

(1) The narrow fish passage vertical slot generates a high-speed jet, and an inertial force of the water flow forms a stable flow in a form of a jet along the side walls of the main flow arc segment. The shear stress between the jet and the side walls of the main flow arc segment dominates the energy dissipation of the water body, followed by the friction shear force between the jet and the recirculating water body, resulting in a good energy dissipation effect. Furthermore, after adopting the curved deflector, the curved deflector makes the main flow in the fishway pool chamber present an S-shaped distrib plateution, and the main flow path is longer than that of a fishway without the curved deflector. After further adding the first rib plates, the fish-attracting and guiding cylinder, the second rib plates and the third rib plates, the energy dissipation method has been changed to various combinations of side wall+collision+energy dissipation along the path, resulting in higher energy dissipation efficiency.

(2) The main flow in the Taiji fishway of the present disclosure flows along the curved side wall and then passes through the curved deflector from the outlet of the previous fishway pool chamber unit to the inlet of the next fishway pool chamber unit. In the remaining part of the pool chamber, a stable circulation slow-flow zone is formed along the main flow direction, providing a resting water space for upstream fish. It can maintain a stable flow pattern with clear main flow and distinct dynamic and static characteristics under different working conditions such as water depths and flow rates, featuring strong applicability and compatibility. Combined with the biohydraulic model experiments describ plateed later, it can be seen that the vertical slot velocity of the Taiji fishway of the present disclosure is small and the water level difference between pool chambers is small, indicating that under the same external conditions, the water flow condition of the Taiji fishway of the present disclosure is better than that of the standard vertical slot fishway, with less flow loss and less likely to generate a hairpin vortex in the pool chamber. Therefore, it can maintain a stable flow pattern with clear main flow and distinct dynamic and static characteristics under different working conditions such as water depths and flow rates.

### BRIEF DESCRIPTION OF DRAWINGS

To describ platee the technical solutions in the embodiments of the present disclosure or in the related art more clearly, the following briefly introduces the accompanying drawings for describ plateing the embodiments or the related art. Apparently, the accompanying drawings in the following description show merely some of the embodiments of the present disclosure, and a person of ordinary skill in the art can still derive other drawings from the accompanying drawings without creative efforts.

FIG. 1 is a schematic structure diagram of a standard vertical slot fishway in the prior art;

FIG. 2 is a relationship curve between pool chamber water depth and passage efficiency of the standard vertical slot fishway in the prior art;

FIG. 3 is a schematic diagram of a hairpin vortex in a fishway pool chamber of the standard vertical slot fishway in the prior art;

FIG. 4 is a schematic diagram of hairpin vortex and their influence on fish behavior in the fishway pool chamber of the standard vertical slot fishway under a shallow water condition in the prior art;

FIG. 5 is a schematic diagram of hairpin vortex and their influence on fish behavior in the fishway pool chamber of the standard vertical slot fishway under a deep-water condition in the prior art;

FIG. 6 is a schematic structural diagram of a Taiji fishway in an embodiment of the present disclosure;

FIG. 7 is a schematic structural diagram of a fishway pool chamber unit in an embodiment of the present disclosure;

FIG. 8 is a schematic structure diagram of a Taiji fishway with first rib plates in an embodiment of the present disclosure;

FIG. 9 is a schematic diagram of a vortex street generated when target fish swim;

FIG. 10 is a schematic diagram of a Taiji fishway with the first rib plates and a fish-attracting and guiding cylinder in an embodiment of the present disclosure;

FIG. 11 is a schematic structure diagram of a Taiji fishway with the first rib plates, the fish-attracting and guiding cylinder, a second rib plates and a third rib plates in an embodiment of the present disclosure;

FIG. 12 is a schematic diagram of the three-dimensional structure of FIG. 11;

FIG. 13 is cloud diagram of a flow velocity field of a fishway in an embodiment of the present disclosure;

FIG. 14 is a schematic diagram of a fishway flow field without an curved deflector in a biohydraulics model experiment in an embodiment of the present disclosure;

FIG. 15 is schematic diagram of a fishway flow field with a curved deflector in the biohydraulics model experiment in an embodiment of the present disclosure;

FIG. 16 is a schematic diagram of a fishway flow field with the curved deflector, the first rib plates, the fish-attracting and guiding cylinder, the second rib plates and the third rib plates in the biohydraulic model experiment in an embodiment of the present disclosure.

The purpose, features and advantages of the present disclosure will be further describ plateed in conjunction with the embodiments and with reference to the accompanying drawings.

### Explanation of Reference Numerals in Drawings

10. Fishway pool chamber unit; 110. curved side wall; 111. First arc segment; 112. Straight segment; 113. Second arc segment; 120. curved deflector; 121. Head end of the curved deflector; 122. Tail end of the curved deflector; 130. First longitudinal side wall; 140. fishway vertical partition plate; 150. Second longitudinal side wall; 160. fish passage vertical slot; 171. First rib plates; 172. fish-attracting and guiding cylinder; 173. Second rib plates; 174. Third rib plates; 180. Main flow section; 190. circulation slow-flow zone; 20. Standard vertical slot fishway; 30. Hairpin vortex; 40. Vortex street; 50. Target fish.

### DETAILED DESCRIPTION OF THE EMBODIMENTS

It should be understood that the specific embodiments describ plateed herein are only used to explain the present disclosure, and are not intended to limit the present disclosure.

The following will be combined with the drawings in the embodiments of the present disclosure to clearly and completely describ platee the technical solutions in the embodiments of the present disclosure. Obviously, the describ plateed embodiments are only part of the embodiments of the present disclosure, not all of the embodiments. Based on the embodiments of the present disclosure, all other embodiments obtained by a person of ordinary skill in the art without creative efforts shall fall within the protection scope of the present disclosure.

It should be noted that all directional indications (such as up, down, left, right, front, back, etc.) in the embodiments of the present disclosure are only used to explain the relative position relationship, movement status, etc. of each component under a certain specific posture (as shown in the accompanying drawings). If the specific posture changes, the directional indication will also change accordingly.

In addition, the descriptions of “first”, “second”, etc. in the present disclosure are only used for descriptive purposes and cannot be understood as indicating or implying their relative importance or implicitly indicating the number of the indicated technical features. Therefore, the features that are limited to “first” and “second” can explicitly or implicitly include at least one of the features. In addition, the technical solutions between various embodiments can be combined with each other, but they must be based on the ability of a person of ordinary skill in the art to implement them. When the combination of technical solutions is contradictory or cannot be implemented, it should be deemed that such a combination of technical solutions does not exist and is not within the protection scope required by the present disclosure.

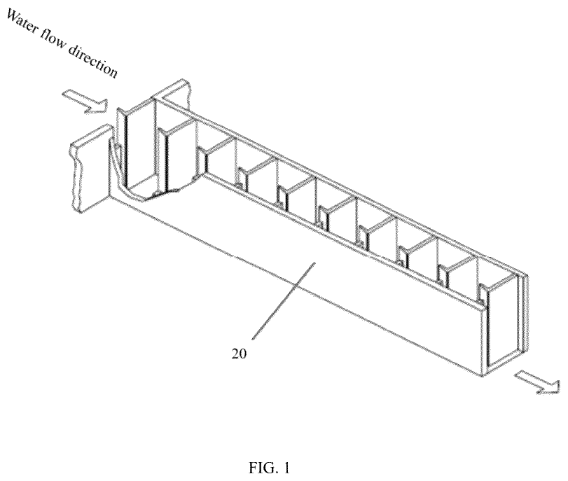

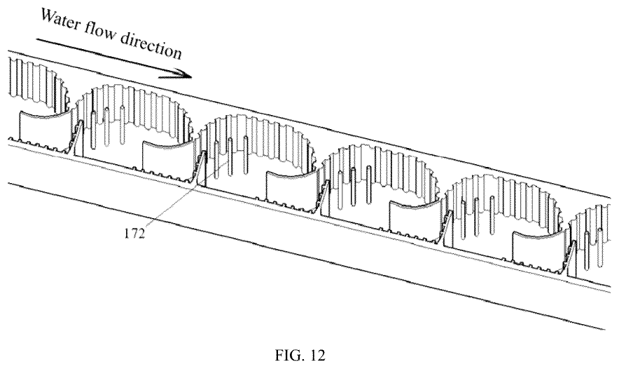

Please refer to FIGS. 1 to 13, a Taiji fishway structure in an embodiment of the present disclosure includes a plurality of fishway pool chamber units 10 arranged in sequence along the water flow direction, each fishway pool chamber unit 10 includes an curved side wall 110, an curved deflector 120, and a first longitudinal side wall 130, a fishway vertical partition plate 140, and a second longitudinal side wall 150 provided on the same side of the fishway. As shown in FIG. 12, the curved side wall 110 is located on a left side of the water flow direction, and the first longitudinal side wall 130 is located on a right side of the water flow direction.

The curved side wall 110 is arranged on the opposite side of the second longitudinal side wall 150, the curved side wall 110 is bent toward the second longitudinal side wall 150 and extends along the water flow direction, the curved deflector 120 is arranged on an inner side of the curved side wall 110, and the curved deflector 120 is bent toward the curved side wall 110, the curved deflector 120 includes a head end and a tail end arranged opposite to each other along the water flow direction, the head end of the curved deflector 121 is connected with the tail end of the curved side wall 110, and the tail end of the curved deflector 122 extends from the head end of the curved deflector 121 to the middle area of the fishway pool chamber;

The first longitudinal side wall 130 is disposed upstream of the fishway vertical partition plate 140 and extends longitudinally along the fishway, the fishway vertical partition plate 140 is perpendicular to the first longitudinal side wall 130, and the second longitudinal side wall 150 is disposed downstream of the fishway vertical partition plate 140 and extends longitudinally along the fishway;

Among them, the head end 121 of the curved deflector in the i-th fishway pool chamber unit 10 is connected to the head end of the curved side wall 110 in the (i+1)th fishway pool chamber unit 10, and the head end of the curved deflector 121 in the i-th fishway pool chamber unit 10 and the end of the fishway vertical partition plate 140 in the (i+1)th fishway pool chamber unit 10 (i.e., an end away from the second longitudinal side wall 150) form a fish passage vertical slot 160 that matches the target fish, and the water flow in the i-th fishway pool chamber unit 10 is ejected toward the curved side wall 110 in the (i+1)th fishway pool chamber unit 10 through the fish passage vertical slot 160; wherein, i is a positive integer, i≥1.

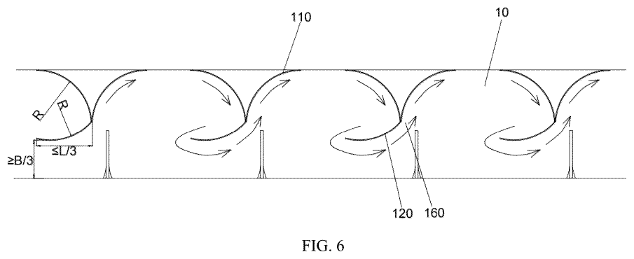

Specifically, as shown in FIG. 6, the fishway of the present disclosure includes a plurality of fishway pool chamber units 10 arranged in sequence along the water flow direction. Fish pass through each fishway pool chamber unit 10 in the direction opposite to the water flow. Each fishway pool chamber unit 10 includes an curved side wall 110, an curved deflector 120, and a first longitudinal side wall 130, a fishway vertical partition plate 140, and a second longitudinal side wall 150 provided on the same side of the fishway. The designed curved side wall 110 imitates the curved shape of natural river channels, which helps to guide the water flow and form a specific flow field. The design of the curved side wall 110 also reduces the collision risk of the fish with the side wall during migration. To further improve the practicality and efficiency of the Taiji vertical slot fishway, the present disclosure also adds the curved deflector 120 at the tail end of the curved side wall 110, whose function is to increase the collision energy dissipation of the main flow and the friction energy dissipation with the water. In addition, the main flow path is also increased, thereby improving the energy dissipation effect.

As an optionally embodiment, the curved deflector 120 is an curved plate with a radius equal to a radius of the second arc segment 113, a projected length of the curved deflector 120 on the second longitudinal side wall 150 is ≤L/3, and a distance between the curved deflector 120 and the second longitudinal side wall 150 is ≥B/3, so that a water flow velocity at a confluence of the pool chamber outlet in the fishway pool chamber unit 10 is not greater than a water flow velocity at the fish passage vertical slot 160; wherein L is a length of the fishway pool chamber unit 10 along the water flow direction, and B is a width of the fishway pool chamber unit 10.

The present disclosure increases the area of the fishway pool chamber by setting a fishway vertical partition plate 140 (similar to a straight plate), thereby providing more resting water space for upstream fish.

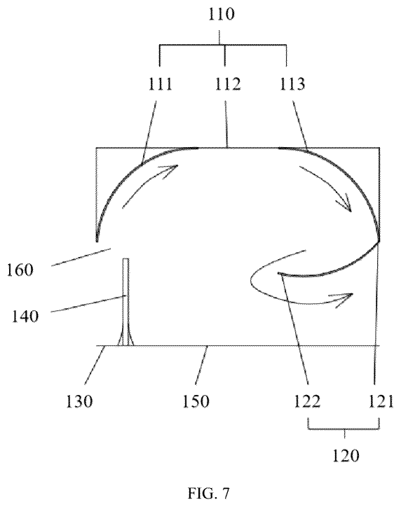

It is worth noting that as shown in FIGS. 6-7, the water flow characteristics of the Taiji fishway in the present disclosure are as follows: the main flow always follows the curved side wall from the outlet section of the upper pool chamber to the inlet section of the lower pool chamber, while a stable circulation slow-flow zone 190 is formed in the remaining part of the pool chamber along the main flow direction.

The energy dissipation characteristics of this configuration are as follows: the narrowed vertical slot generates high-speed jet, and the inertial force of the water flow forms a stable flow in a form of the jet along the curved side wall. The shear stress between the jet and the curved side wall 110 dominates the energy dissipation of the water body, followed by the friction shear force between the jet and the recirculating water body. Additionally, the fishway can maintain a stable flow pattern under different water depths and flow conditions, demonstrating strong applicability and compatibility.

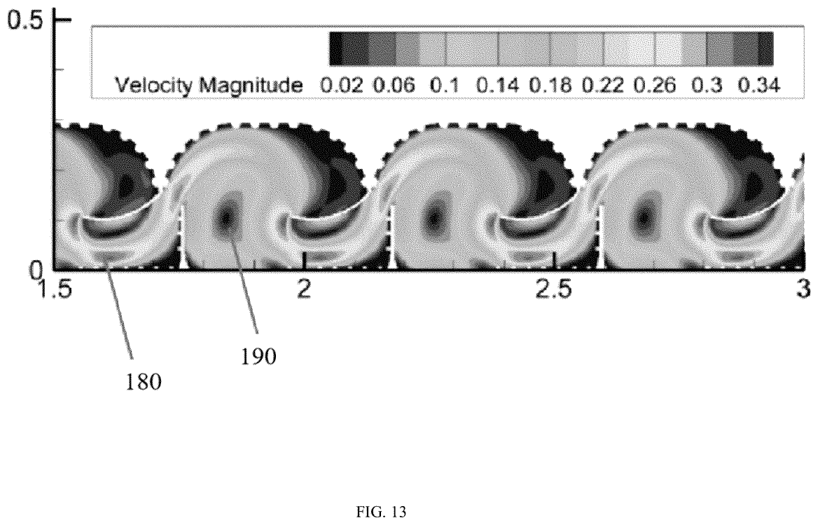

The variable i is introduced in the present disclosure to intuitively describ platee a relationship between two adjacent fishway pool chamber units 10. The value of the variable i increases sequentially along the water flow direction. Specifically, a fish passage vertical slot 160 matching the target fish is formed between the head end of the curved deflector 121 in the i-th fishway pool chamber unit 10 and the tail end of the fishway vertical partition plate 140 in the (i+1)th fishway pool chamber unit 10, realizing the connection of water flow and fish between adjacent fishway pool chamber units 10. When water flow enters the (i+1)th fishway pool chamber unit 10 from the i-th fishway pool chamber unit 10 through the fish passage vertical slot 160, since the fish passage vertical slot 160 suddenly becomes narrower than the width of the pool chamber, the water flow generates a high-speed jet in the narrowed fish passage vertical slot 160. The head end of the curved deflector 121 in the i-th fishway pool chamber unit 10 is connected to the head end of the curved side wall 110 in the (i+1)th fishway pool chamber unit 10. The water flow in the form of high-speed jet flows toward the curved side wall 110 of the (i+1)th fishway pool chamber unit 10, flows along the curved side wall 110, then along the curved deflector 120, and finally flows through the fish passage vertical slot 160 to the next fishway pool chamber unit 10. Refer to FIG. 13, which is a schematic diagram of the flow field corresponding to the Taiji fishway structure of the present disclosure, and the Velocity Magnitude in the FIG. 13 represents the flow velocity magnitude.

Secondly, the width of the fish passage vertical slot 160 of the present disclosure matches the target fish, such as China's native cyprinidae fish, enabling it to be applicable to cyprinidae fish of different body sizes with strong adaptability. Cyprinidae fish can pass through the fish passage vertical slot 160 and smoothly enter another fishway pool chamber unit 10 from one fishway pool chamber unit 10 against the water flow direction, until completing the entire migration.

In the embodiments of the present disclosure, the narrowed fish passage vertical slot 160 generates a high-speed jet, and the inertial force of the water flow forms a stable flow in a form of the jet along the main flow arc segment side wall. The shear stress between the jet and the main flow arc segment side wall dominates the energy dissipation of the water body, followed by the friction shear force between the jet and the recirculating water body, which has a better energy dissipation effect than the existing standard L-type vertical slot fishway.

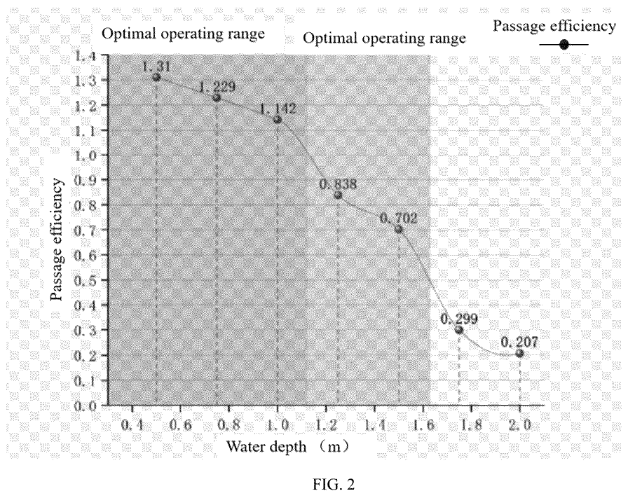

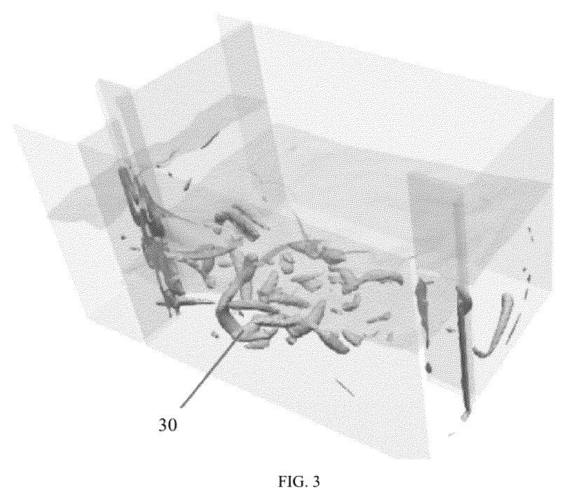

It should be noted by those skilled in the art that the applicant has conducted a large number of experimental studies on upstream behaviors and influencing factors of target fish, especially cyprinidae fish, in the vertical slot fishway. The research found that since cyprinidae fish mainly like to swim in the middle and bottom layers, the passage efficiency of the standard vertical slot fishway 20 is not only affected by the water flow velocity generally recognized, but also related to the water flow pattern of the fishway pool chamber, particularly the water depth of the fishway that is not well known. FIG. 2 shows the relationship between the fishway passage efficiency and the water depth of the pool chamber when the fishway type, geometric dimensions and slope ratio are constant. It can be seen from the Figure that when the slope ratio is 1/70, when the water depth of the fishway pool chamber is in a range of 0.5 to 1.0 m, the passage efficiency of the target fish is relatively high; when the water depth is in a range of 1.1 to 1.5 m, the passage efficiency of the target fish is barely acceptable; when the water depth is in a range of 1.5 to 2.0 m, the passage efficiency of the target fish is relatively low. Further research also revealed that the turbulence generated by the jet of the standard vertical slot fishway 20 will be transformed into a rapidly rotating downward vertical axis vortex structure under appropriate water depth conditions (when the water depth of the pool chamber is large). The rotation axis of this vortex structure undergoes drastic changes at the bottom of the pool chamber, generating unstable hairpin vortex 30, as shown in FIG. 3, resulting in complex three-dimensional water flow characteristics in the middle and bottom layers of the pool chamber.

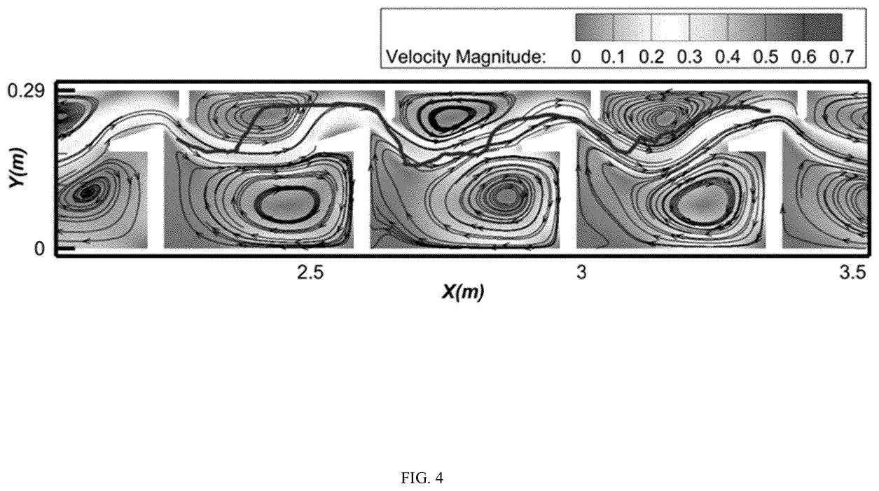

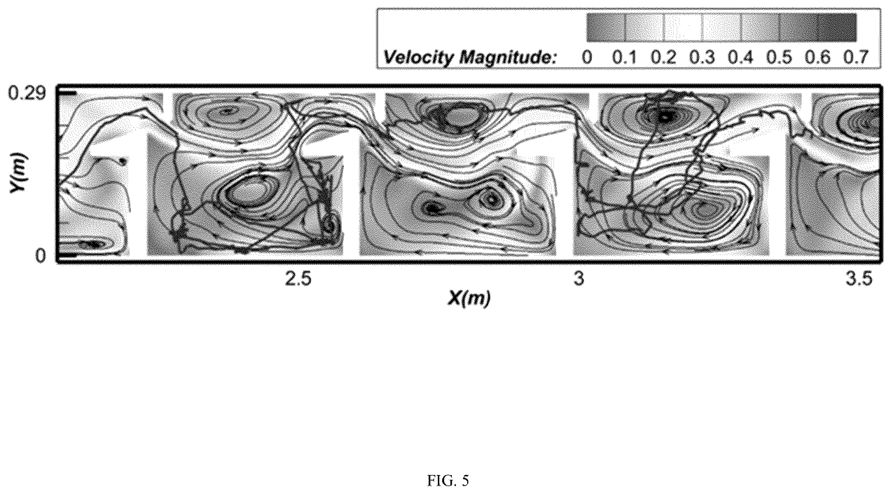

As shown in FIGS. 4-5, solid black lines represent upstream trajectories of fish. For cyprinid fish that prefer to swim in the middle and bottom layers, this water flow condition can easily cause them to lose their direction and lack the motivation to swim upstream. The flow patterns of the standard vertical slot fishway 20 and the behavioral trajectories of fish shown in FIGS. 4-5 also illustrate this issue.

As shown in FIGS. 13-16, the main flow in the Taiji fishway of the present disclosure flows along the curved side wall 110 and then passes through the curved deflector 120 from the outlet of the previous fishway pool chamber unit 10 to the inlet of the next fishway pool chamber unit 10. In the remaining part of the pool chamber, a stable circulation slow-flow zone 190 is formed along the main flow direction, providing a resting water space for upstream fish. It can maintain a stable flow pattern with clear main flow and distinct dynamic and static characteristics under different working conditions such as water depths and flow rates, featuring strong applicability and compatibility. Combined with the biohydraulic model experiments describ plateed later, it can be seen that the vertical slot velocity of the Taiji fishway of the present disclosure is small and the water level difference between pool chambers is small, indicating that under the same external conditions, the water flow condition of the Taiji fishway of the present disclosure is better than that of the standard vertical slot fishway 20, with less flow loss and less likely to generate a hairpin vortex 30 in the pool chamber. Therefore, it can maintain a stable flow pattern with clear main flow and distinct dynamic and static characteristics under different working conditions such as water depths and flow rates.

It is worth noting that, as shown in FIGS. 13-16, according to the characteristics of the water flow in the fishway, the fishway can be named “Taiji fishway”. Firstly, the meandering pattern of the main flow in the fishway and the circular circulation slow-flow zone 190 are similar to the Chinese Taiji diagram; secondly, the dynamic water in the fishway is rippling, and the static water is stable, reflecting a harmonious balance between movement and stillness; thirdly, the water flow conditions of the fishway are similar to meandering natural rivers, which is in line with the natural attrib plateute of fish swimming upstream. Following the natural course and harnessing natural principles also align with the philosophical essence of Tai Chi.

As an optionally embodiment, the curved side wall 110 of each fishway pool chamber unit 10 includes a first arc segment 111, a straight segment 112 and a second arc segment 113 connected sequentially along the water flow direction, the tail end of the first arc segment 111 is tangent to a head end of the straight segment 112, a tail end of the straight segment 112 is tangent to a head end of the second arc segment 113, and a tail end of the second arc segment 113 is connected to the head end of the curved deflector 121.

Specifically, in order to fully utilize an area of the fishway pool chamber in the embodiment, in a preferred example, the curved side wall 110 is divided into 1/4 arc (the first arc segment)+the straight segment 112+1/4 arc (the second arc segment) to facilitate adjusting a length of the fishway pool chamber and increase an applicability of the fishway.

As an optionally embodiment, the curved side wall 110 is provided with a plurality of first rib plates 171 arranged at intervals along an extension direction of the curved side wall 110.

It is worth noting that, taking characteristic of the fact that the main flow in the Taiji vertical slot fishway runs along the curved side wall 110, roughness (such as installing roughened rib plates, convex and concave side walls, clustered and horizontal grid frames, vertical and horizontal rib plate plates, etc.) of the main flow curved side wall 110 is increased, to increase the physical friction and collision between the main flow and the side walls, and improve the energy dissipation effect of the fishway pool chamber.

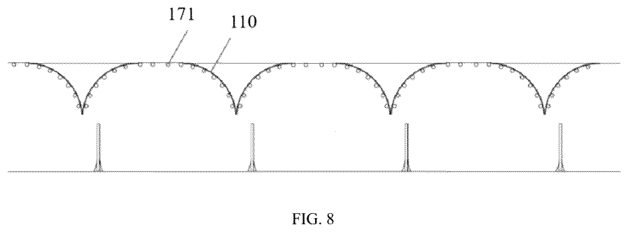

The optimal roughness measures for the side walls should prioritize main flow energy dissipation and simultaneously generate vortex structures beneficial for fish upstream migration. The specific materials, layout, and structural dimensions can be determined through model experiments. Taking the first rib plates 171 shown in FIG. 8 as an example, for cyprinid fish, it is advisable to use a D-shaped column (trapezoidal columns) with a height of 10 to 15 cm and a width of 8 to 10 cm, with a spacing of 2˜3 times a column width between columns.

As an optionally embodiment, Taiji fishway structure further includes a plurality of fish-attracting and guiding cylinders 172 arranged downstream of the fish passage vertical slot 160, and the plurality of fish-attracting and guiding cylinders 172 are arranged in series.

As an optionally embodiment, a number of the fish-attracting and guiding cylinders 172 is three, an angle between an arrangement direction of the three fish-attracting and guiding cylinders 172 and the longitudinal direction of the fishway is set to 20°˜30°, and a spacing between a most upstream fish-attracting and guiding cylinder 172 and the end of the fishway vertical partition plate 140 is equal to a width of the fish passage vertical slot 160, and a spacing between two adjacent fish-attracting and guiding cylinders 172 is set to 2 to 3 times a diameter of the fish-attracting and guiding cylinder 172.

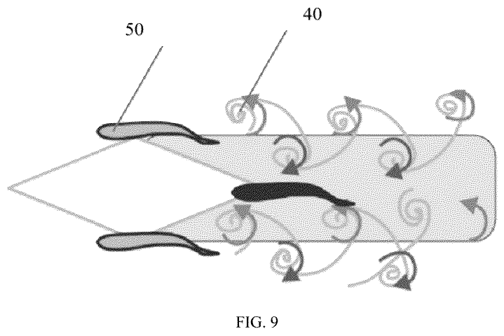

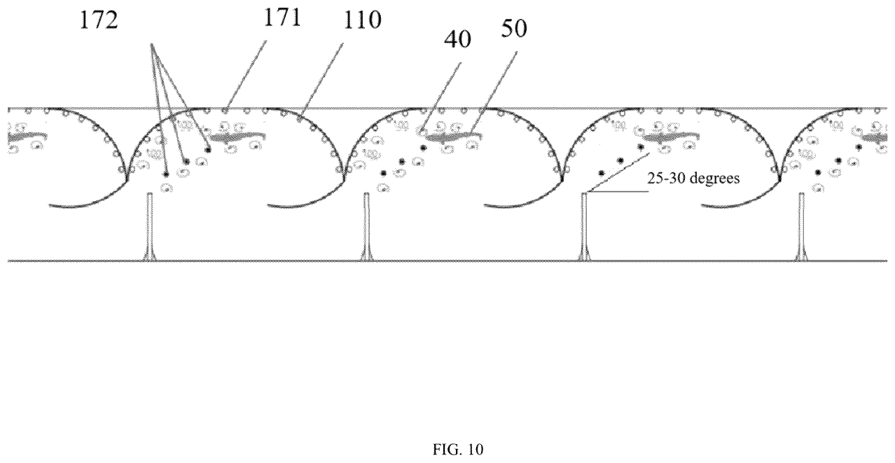

It should be noted that fish swimming has a behavioral characteristic of “group effect” and its mechanism is that the vortex street 40 generated by the tail fin swing of the leading fish can induce the following fish school, so that the fish school can easily follow the team with the help of the vortex, as shown in FIG. 9. Using this mechanism, three series-arranged fish-attracting and guiding cylinders 172 are placed at a rapid flow of the fish passage vertical slot 160, which not only reduce an energy of the rapid flow, but also generate an artificial vortex street 40 behind the fish-attracting and guiding cylinders 172 to attract and guide fish, as shown in FIG. 10.

As another optionally embodiment, the Taiji fishway structure includes a plurality of second rib plates 173 and a plurality of third rib plates 174. The plurality of second rib plates 173 are arranged in an area where the curved deflector 120 is projected on the second longitudinal side wall 150, and are arranged at intervals along an extension direction of the second longitudinal side wall 150. The plurality of third rib plates 174 are arranged on a wall surface of the fishway vertical partition plate 140 closes to the second rib plates 173, and are arranged at intervals along an extension direction of the fishway vertical partition plate 140.

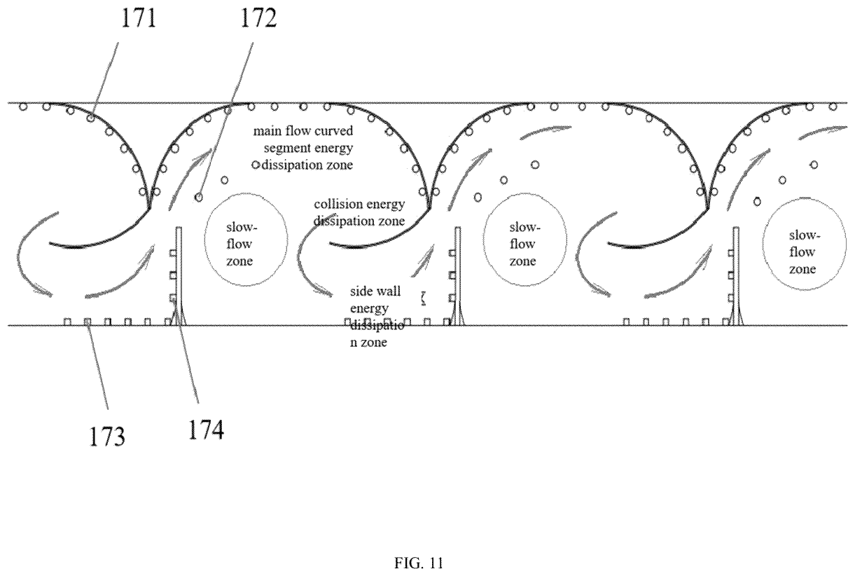

It is worth noting that after passing through the curved deflector 120, the water flow in the fishway pool chamber will shrink sharply before entering the outlet section of the fishway pool chamber, and then generate rapids again on the side walls of the outlet section. Therefore, the roughness (such as convex and concave side walls, clustered and horizontal grid frames, vertical and horizontal rib plate plates, etc., as shown in FIG. 11-12) is increased here (in the area where the curved deflector 120 is projected on the second longitudinal side wall 150 and the wall surface of the fishway vertical partition plate 140 close to the second rib plates 173), the physical friction and collision between the main flow and the side walls are increased, which improves the energy dissipation effect of the fishway pool chamber. A curved arrow in FIG. 11 represents the main flow section 180, and a circular line represents the circulation slow-flow zone 190.

As an optionally embodiment, the width of the fish passage vertical slot 160 is set between 0.4 and 0.6 m, and the width of the fishway pool chamber unit 10 is set between 2.5 and 3.5 meters. It is worth noting that the width of the fish passage vertical slot 160 is mainly determined by body width and body length of the target fish, taking into account a formation of the water flow conditions in the fishway pool chamber. For example, for cyprinid fish, the width of the fish passage vertical slot 160 is optionally set between 0.3 and 0.4 meters. The determination of the width of the fishway pool chamber unit 10 mainly considers the body length of the target fish and the formation of the water flow conditions in the fishway pool chamber. For example, for cyprinid fish, B is generally taken as 2.5˜3.5 meters.

Furthermore, the length L of the fishway pool chamber unit 10 along the water flow direction is determined by a formula L=K*B, wherein B is the width of the fishway pool chamber unit 10, K is a coefficient, and K is taken as 1.25˜1.5.

Furthermore, the length 1 of the fishway vertical partition plate 140 is determined by a formula 1≥B/2.

Furthermore, a radius of the first arc segment is equal to the radius of the second arc segment, and the radius R of the first arc segment and the second arc segment is determined by a formula R≤B/2.

Furthermore, a length D of the straight segment 112 is determined by a formula D=L-2R.

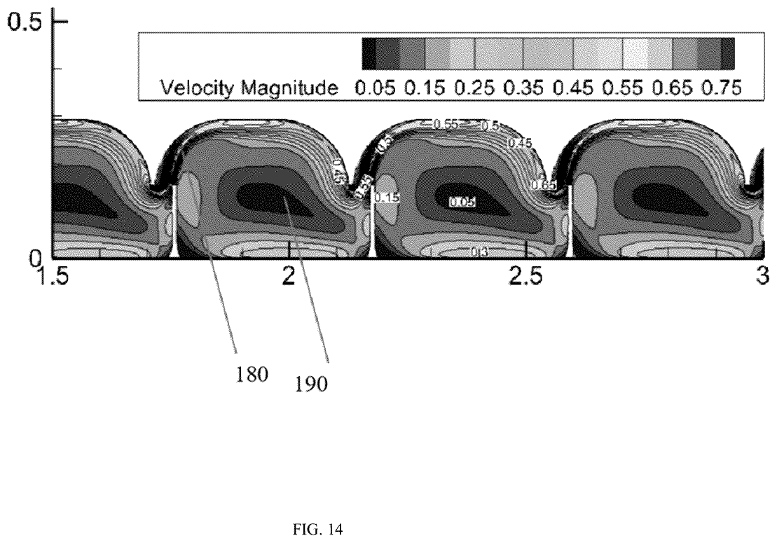

As an optionally embodiment, as shown in FIGS. 14-16, the present disclosure also studies and analyzes hydraulic characteristics and fish passage effect of the Taiji fishway of the present disclosure through a biohydraulic model experiment method, as follows:

### 1. Hydrobiological Hydraulic Model Experiment

The hydrobiological hydraulic model experiment for the fishway integrates hydraulics and hydrobiology research. Physical experiments are carried out to simulate hydraulic characteristics of the fishway with different structural types and different boundary conditions. Target fish are placed in the model to study the impact of specific water flow conditions on their behavior, so as to assess a rationality of fishway design.

### 2. Experimental Methods

### 2.1 Experimental Conditions

The hydrobiological hydraulic model experiment is a highly complex experimental study that requires strict experimental conditions. The hydrobiological hydraulic model laboratory is mainly composed of an ecological environment simulation (water quality pH, dissolved oxygen concentration, water temperature, room temperature, illumination, etc.) monitoring and control system, a variable slope flume, a water circulation system, a fish behavior monitoring system, etc.

The state of the experimental fish is highly susceptible to environmental changes. To ensure the reliability and repeatability of the experiments, strict requirements are imposed on the aquatic environment. To minimize the stress response of the experimental fish caused by environmental fluctuations, the experimental water bodies of the laboratory experimental fish temporary holding pond and the variable slope flume in the laboratory are both in a same system. The ecological environment simulation monitoring and control system must be turned on throughout the day during both experimental and non-experimental time periods to ensure that the water environment and the experimental fish are in optimal and stable conditions.

The experimental water temperature is controlled at 25±1° C. in summer and autumn, and at 20+1° C. in winter and spring. Dissolved oxygen concentration is maintained above 8.50 mg/L, and the water quality pH is maintained at around 7.5.

### 2.2 Experimental Condition

Take an experimental condition of a slope of 1/40, a flow rate of 4 m³/h (1.11 L/s, prototype 0.309 m³/s), and an average water depth of approximately 10 cm (prototype water depth 1.0 m) as an example, the hydrobiological hydraulic model experiment is conducted.

### 2.3 Hydraulic Parameters Measurement

The hydraulic parameters measured in the model experiment mainly include a flow velocity at the vertical slot, a water depth in the pool chamber, a water level difference between pool chambers, a flow pattern and a flow field distrib plateution.

### 2.4 Aquatic Biological Experiments

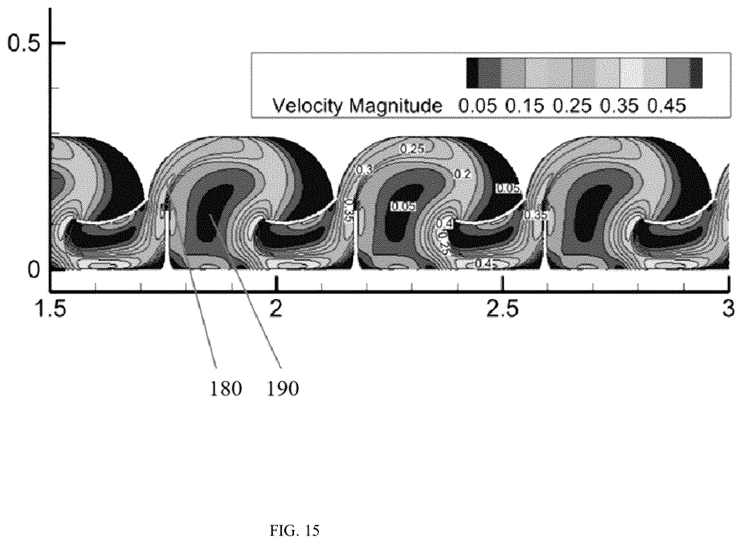

In order to obtain reliable and statistically significant biological experimental results, each experiment must ensure a sufficient number of experimental fish. For each group of comparative experiments, 10 experimental fish were randomly placed in downstream pool chambers of the fishway without the curved deflector 120 and the Taiji vertical slot fishway, respectively, and three repeated experiments were conducted. A high-speed camera (Hikvision video surveillance camera, model DS-2CD3386FWDV3-LS, FIG. 15) was installed above the fishway model. A single video has a frame width of 1920, and a frame height of 1080. A data rate and a total bit rate are 2515 kbps, and a frame rate is 15.00 frames per second. Behavioral characteristics of fish swimming upstream during the experiments are recorded in real time. Video data of each group of experiments is immediately numbered and stored in a fixed memory for later extraction and data analysis.

### 3. Analysis of Experimental Results

A series of energy dissipation measures and fish attracting and guiding measures taken for the fishway pool chamber without the curved deflector 120, and the fishway finally formed with the curved deflector 120, the first rib plates 171, the fish-attracting and guiding cylinder 172, the second rib plates 173 and the third rib plates 174 were experimented and analyzed, as shown in FIGS. 14-16. Multiple groups of repeated experimental studies were conducted on its hydraulic characteristic parameters and fish passage effect. The specific experiment and analysis results are as follows:

### 3.1 Analysis of Hydraulic Parameters

The experiment results of hydraulic parameters such as the flow velocity at the vertical slot, the flow pattern, the water depth in the pool chamber, the water level difference between pool chambers, and flow velocity coefficient of the fishway without the curved deflector 120 and with the curved deflector 120, the first rib plates 171, the fish-attracting and guiding cylinder 172, the second rib plates 173, and the third rib plates 174 are shown in Table 1 and FIGS. 14-16.

From a comparison of FIGS. 14-16, it can be seen that after adopting the curved deflector 120, the main flow in the fishway pool chamber (shown in FIG. 15) shows an S-shaped distrib plateution, and the main flow path is longer than that of the fishway without the curved deflector 120. The energy dissipation method has been changed to a combination of side walls+collision+energy dissipation along the way, resulting in higher energy dissipation efficiency. The energy dissipation effect is directly reflected in the flow velocity distrib plateution of the fishway pool chamber. From FIG. 14, it can be seen that the main flow velocity in the fishway pool chamber without the curved deflector 120 is between 0.45 m/s and 0.65 m/s, and the flow velocity at the vertical slot is 0.55 m/s. After adding the curved deflector 120, the main flow velocity in the fishway pool chamber is between 0.25 m/s and 0.40 m/s, and the flow velocity at the vertical slot is 0.32 m/s, which is approximately 42% lower than before. The effect was very significant.

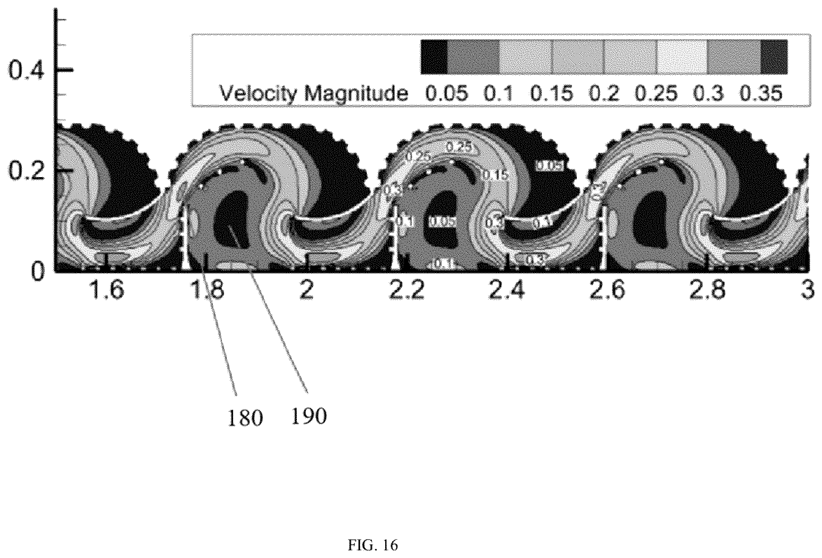

From a comparison of the flow velocity distrib plateution nephograms of the fishway pool chambers in FIGS. 15 and 16, it can be seen that after continuing to adopt energy dissipation measures with roughness on the pool chamber side walls (such as convex and concave side walls, clustered and horizontal grid frames, vertical and horizontal rib plate plates, etc.), A curved arrow in FIG. 11 represents the main flow section 180, and a circular line represents the circulation slow-flow zone 190.

The physical friction and collision between the main flow and the side walls are increased, which improves the energy dissipation effect of the fishway pool chambers. As shown in the figures, the main flow velocity in the fishway pool chamber is reduced from0.25˜0.40 m/s to 0.15˜0.30 m/s, and the flow velocity at the vertical slot is reduced from 0.30 m/s to 0.30 m/s. The energy dissipation effect is also very obvious.

TABLE 1
hydraulic parameters of the fishway corresponding
to FIG. 14 and the fishway corresponding to FIG. 16

| | flow | | | | Power |
|---|---|---|---|---|---|
| | velocity | water level | | | Dissipation |
| | at the | difference | water depth | | Rate per |
| | vertical | between pool | in the pool | flow | Unit Water |
| | slot | chambers | chamber | velocity | Volume |
| Fishway type | (m/s) | (cm) | (cm) | coefficient | (W/m³) |
| fishway | 0.55 | 1.60 | 10.0 | 0.98 | 75.66 |
| corresponding | | | | | |
| to FIG. 14 | | | | | |
| fishway | 0.30 | 0.86 | 10.0 | 0.73 | 28.56 |
| corresponding | | | | | |
| to FIG. 16 | | | | | |

The following parameters were calculated based on results of the model experiments:

Flow velocity coefficient:

$$ϕ = \frac{v}{\sqrt{2 g Δ h}} ;$$

wherein, v is the flow velocity measured at the vertical slot of the fishway, m/s; Δh is a water level difference between the fishway vertical partition plates, m; g is the gravitational acceleration, m/s2;

Power dissipation rate per unit water volume:

$$E = \frac{p {g}^{c} Δ hQ}{V} \leq [ E ] ;$$

wherein, E is a power dissipation rate per unit water volume, W/m3; [E] is an allowable power dissipation rate per unit water volume, W/m3; V is a water volume of the fishway pool chamber, m³; Δh is a water level difference between the fishway vertical partition plates, m; g is the gravitational acceleration, m/s²; Q is a flow rate through the fishway pool chamber, m³/s; p is a density of water, kg/m³.

It can be seen from the results in Table 1, the vertical slot velocity and the water level difference between pool chambers of Taiji fishway corresponding to FIG. 16, and the power dissipation rate per unit water volume are all lower than those of the fishway corresponding to FIG. 14. This indicates that under the same external conditions, the energy dissipation effect of the fishway corresponding to FIG. 16 is better than that of the fishway without the curved deflector 120 corresponding to FIG. 14.

### 3.2 Analysis of Hydrobiological Parameters

### (1) Fish Passage Rate (Pr)

The fish passage rate (Pr) is defined as a percentage of a number of experimental fish that successfully upstreamed relative to a total number of experimental fish;

$$Pr = \frac{number of successfully upstreamed experimental fish}{total number of experimental fish} \times 100 \%$$

The experimental fish that successfully upstreamed are defined as those that autonomously upstreamed successfully.

As shown in Table 2: under the same environmental factors and similar water flow conditions, a fish passage rate of the experimental fish in the fishway without the curved deflector 120 corresponding to FIG. 14 is 70%, while a fish passage rate of the Taiji fishway corresponding to FIG. 16 is 86.7%. Under this operating condition, the upstream fish passage rate of the experimental fish in the Taiji fishway corresponding to FIG. 16 is 23.9% higher than that in the fishway without the curved deflector 120 corresponding to FIG. 14.

TABLE 2
fish passage rate and passage time of the fishway corresponding
to FIG. 14 and the fishway corresponding to FIG. 16

| | operating | | | | |
|---|---|---|---|---|---|
| | condition | | | | |
| | (Q = 4 m3/h, | Exper- | Exper- | Exper- | Average |
| | H = 10 cm) | iment 1 | iment 2 | iment 3 | value |
| fishway | fish passage rate | 70% | 60% | 80% | 70% |
| corresponding | | | | | |
| to FIG. 14 | | | | | |
| fishway | fish passage rate | 80% | 90% | 90% | 86.7% |
| corresponding | | | | | |
| to FIG. 16 | | | | | |

### (2) Macroscopic Analysis of Energy Consumption

The physical energy consumption of the target fish during upstream migration is an important indicator of biological parameters. From the flow velocity difference at the vertical slot of the two fishways in Table 1, as well as the comparison in FIGS. 14-16, it can be concluded that the water flow in the Taiji fishway corresponding to FIG. 16 is gentler than that in the fishway without the curved deflector 120 corresponding to FIG. 14. From the experiments and the video data, it can also be seen that the tail-wagging frequency and amplitude of the target fish in the Taiji fishway pool chamber corresponding to FIG. 16 are smaller than those in the fishway without the curved deflector 120 corresponding to FIG. 14, indicating that Taiji fishway corresponding to FIG. 16 has a lower energy consumption during the upstream migration compared to the fishway without the curved deflector 120 corresponding to FIG. 14. It is preliminarily estimated that the energy consumption of the target fish during the upstream migration in the Taiji fishway corresponding to FIG. 16 is 20-30% lower than that in the fishway without the curved deflector 120 corresponding to FIG. 14.

The above are only preferred embodiments of the present disclosure, and are not limit the patent scope of the present disclosure. Any equivalent structure or equivalent process transformation made using the contents of the specification and drawings of the present disclosure, or directly or indirectly applied in other related technical fields, are also included in the patent protection scope of the present disclosure.

What is claimed is:

1. A Taiji fishway structure, comprising a plurality of fishway pool chamber units arranged in sequence along a water flow direction, wherein each fishway pool chamber unit comprises an curved side wall, an curved deflector, and a first longitudinal side wall, a fishway vertical partition plate, and a second longitudinal side wall provided on the same side of the fishway, wherein:
the curved side wall is arranged on an opposite side of the second longitudinal side wall, the curved side wall is bent toward the second longitudinal side wall and extends along the water flow direction, the curved deflector is arranged on an inner side of the curved side wall, and the curved deflector is bent toward the curved side wall, the curved deflector comprises a head end and a tail end arranged opposite to each other along the water flow direction, the head end of the curved deflector is connected to a tail end of the curved side wall, and the tail end of the curved deflector extends from the head end of the curved deflector to a middle area of the fishway pool chamber;
the first longitudinal side wall is arranged upstream of the fishway vertical partition plate and extends longitudinally along a fishway, the fishway vertical partition plate is perpendicular to the first longitudinal side wall, and the second longitudinal side wall is arranged downstream of the fishway vertical partition plate and extends longitudinally along the fishway;
the head end of the curved deflector of the i-th fishway pool chamber unit is connected to the head end of the curved side wall in the (i+1)th fishway pool chamber unit, the head end of the curved deflector of the i-th fishway pool chamber unit and the end of the fishway vertical partition plate in the (i+1)th fishway pool chamber unit form a fish passage vertical slot that matches target fish body size, and water flow of the i-th fishway pool chamber unit is ejected toward the curved side wall in the (i+1)th fishway pool chamber unit through the fish passage vertical slot; wherein i is a positive integer, i≥1.

2. The Taiji fishway structure according to claim 1, wherein the curved side wall of each fishway pool chamber unit comprises a first arc segment, a straight segment and a second arc segment connected sequentially along the water flow direction, a tail end of the first arc segment is tangent to a head end of the straight segment, a tail end of the straight segment is tangent to a head end of the second arc segment, and a tail end of the second arc segment is connected to the head end of the curved deflector.

3. The Taiji fishway structure according to claim 2, wherein the curved deflector is an curved plate with a radius equal to a radius of the second arc segment, a projected length of the curved deflector on the second longitudinal side wall is ≤L/3, and a distance between the curved deflector and the second longitudinal side wall is ≥B/3, so that a water flow velocity at a confluence of a pool chamber outlet in the fishway pool chamber unit is not greater than a water flow velocity at the fish passage vertical slot; wherein L is a length of the fishway pool chamber unit along the water flow direction, and B is a width of the fishway pool chamber unit.

4. The Taiji fishway structure according to claim 1, wherein the curved side wall is provided with a plurality of first rib plates arranged at intervals along an extension direction of the curved side wall.

5. The Taiji fishway structure according to claim 4, further comprising a plurality of fish-attracting and guiding cylinders arranged downstream of the fish passage vertical slot, wherein the plurality of fish-attracting and guiding cylinders are arranged in series.

6. The Taiji fishway structure according to claim 5, wherein a number of the fish-attracting and guiding cylinders is three, an angle between an arrangement direction of the three fish-attracting and guiding cylinders and the longitudinal direction of the fishway is set to 20°˜30°, and a spacing between a most upstream fish-attracting and guiding cylinder and the end of the fishway vertical partition plate is equal to a width of the fish passage vertical slot, and a spacing between two adjacent fish-attracting and guiding cylinders is set to 2 to 3 times a diameter of the fish-attracting and guiding cylinder.

7. The Taiji fishway structure according to claim 5, further comprising a plurality of second rib plates and a plurality of third rib plates, wherein the plurality of second rib plates are arranged in an area where the curved deflector is projected on the second longitudinal side wall, and are arranged at intervals along an extension direction of the second longitudinal side wall, and the plurality of third rib plates are arranged on a wall surface of the fishway vertical partition plate close to the second rib plates, and are arranged at intervals along an extension direction of the fishway vertical partition plate.

8. The Taiji fishway structure according to claim 1, wherein the width of the fish passage vertical slot is set between 0.4 and 0.6 meters, and the width of the fishway pool chamber unit is set between 2.5 and 3.5 meters.

9. The Taiji fishway structure according to claim 8, wherein the length L of the fishway pool chamber unit along the water flow direction is determined by a formula L=K*B, wherein B is the width of the fishway pool chamber unit, K is a coefficient, and K is taken as 1.25˜1.5.

10. The Taiji fishway structure according to claim 9, wherein the length l of the fishway vertical partition plate is determined by a formula 1≥B/2.
